(19) United States
(12) Patent Application Publication
(10) Pub. No.: US 2008/0047871 A1
(43) Pub. Date: Feb. 28, 2008

(54) Crude oil storage and tank maintenance

(75) Inventors: Glen B. Brons, Phillipsburg, NJ (US); Douglas S. Meyer, Fromberg, MT (US); Mohsen N. Harandi, Leesburg, VA (US); Randolph Perry, Rancho Palos Verdes, CA (US); John W. Anthony, Crosby, TX (US); John S. Jackson, Baytown, TX (US)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 11/508,249

(22) Filed: Aug. 23, 2006

(51) Int. Cl. B08B 7/04; B08B 9/00; C10C 3/08

(52) U.S. Cl. 208/45; 134/22.1; 134/10; 210/634; 210/639; 196/46; 208/108; 208/311

(57) ABSTRACT

HSP crude oil is used as process stream in crude oil storage tanks to address sludge levels both by cleaning sludge accumulations and preventing any significant sludge build up when used on a regular basis. HSP crude oil is also used to optimize cleaning routines. Making HSP oil easily accessible by providing a designated HSP source will make tank maintenance more efficient and allow refineries to use the advantages of the HSP oil to the maximum extent.

### BACKGROUND OF THE INVENTION

1. Field of the Invention

This invention relates to processing of whole crude oils, blends and fractions in refineries and petrochemical plants. In particular, this invention relates to crude oil storage tanks and the cleaning, maintenance and management of storage tanks.

2. Discussion of Related Art

Precipitation of asphaltenes in crude oil storage tanks can occur as a result of improper blending of crude oils. For example, improper blending can occur when adding poor-solvent crude oils to tank heels that contain high levels of asphaltenes and/or waxes or adding oils that contain asphaltenes that possess relatively high Insolubility Numbers (In). Such asphaltene precipitates interfere with effective storage tank operation and have a detrimental effect on refinery processes by accelerating fouling in pre-heat train exchangers and furnaces. The precipitates create an accumulation of sludge in the bottoms of storage tanks used for crude oils and other high gravity petroleum products.

Such precipitation can create large sludge build ups, which may accumulate to depths of one meter or more in the large tanks used for crude oils. Extreme levels of over eight feet have been reported. The build up interferes with floating roof operation, mixing, pumping, and measurement. In some instances, the sludge levels are so high that floating roofs can be damaged. The sludges need to be removed from the tanks from time to time to maintain tankage volume and efficient tank operations.

Sludge removal also prevents or decreases contamination of the products moving through the tanks. Oil streams with precipitated asphaltenes will foul heat exchange equipment, particularly the pre-heat train exchangers. As is well known, asphaltene precipitates can accumulate on heated surfaces and coke, forming a layer of residue that is difficult to remove. This is a wide spread problem in refineries and petrochemical plants as it adversely affects efficiency and raises maintenance costs.

The costs to remove sludges can be very high and raise environmental issues. Sludge is difficult to handle efficiently as it is adherent, solid or semi-solid and cannot be moved by conventional fluid handling equipment, such as pumps. Current practices for refinery tank cleaning by physical methods, such as removing the sludge mechanically as a solid material, are time-consuming, labor-intensive and costly.

Alternative cleaning techniques include water washing or solvent removal. Water washing is typically accomplished by jetting water with a dispersant into the sludge to break it up and soften it, after which it can be pumped out in the form of a slurry for disposal, for example in a cement plant. High pressure wash jets promote break up of the mass of sludge. Pressures of up to 100 bar have been used. Softening of the sludge is also assisted by the use of heated water, at temperatures as high as about 45° C.

Solvent washing is less costly and reduces the amount of organic materials that would otherwise need to be disposed. Crude oil is sometimes used as the solvent. The solvent cleaning process involves first emptying the tank of the previous liquid oil contents that are ordinarily stored in the tank. Then, a hot hydrocarbon solvent is introduced into the tank to sufficiently cover the mixers and/or float the roof. Most of the solid hydrocarbons in the sludge will dissolve more quickly and fully with the use of mixing and heat. Mechanical breakup of the sludge can also be achieved by the use of jet injectors for the specific solvent. If heat is not available, longer mixing times or repeated solvent applications are utilized. Following agitation, the hydrocarbon solvent and dissolved materials are pumped from the tank and are recovered through conventional refinery processing. Water or water-based solvents are then introduced into the tank. Mixing and heating improve the degree and rate of dissolution. The water or water-based solvents and dissolved organics are pumped from the tank and processed via the conventional refinery water treating facilities. In practice, however, water wash often fails to remove the oily sludge completely, and solvent removal is not completely effective.

One method of removing sludge is disclosed in related application U.S. Patent Application Publication No. 2006/0042661, published Mar. 2, 2006. The contents of that application are incorporated herein by reference. In this method, a two-step approach utilizes solvent extraction to dissolve organic components of the sludge followed by water wash to remove inorganic materials. Mixing and heating improve the dissolution of soluble materials in both steps of the process.

There is a need, however, to optimize the process of sludge removal, especially by improving the solvent and improving access to beneficial solvents. Additionally, addressing sludge issues prior to high levels of build up would be desirable by optimizing the sludge level management and preventing sludge build up to reduce or eliminate the need for removal.

### BRIEF SUMMARY OF THE INVENTION

Aspects of embodiments of the invention relate to providing an effective method for cleaning sludge from a crude oil storage tank.

Another aspect of embodiments of the invention relates to maintaining a crude oil tank with minimal sludge levels.

An additional aspect of embodiments of the invention relates to optimizing a refining facility by implementing scheduled cleaning and maintenance and providing access to solvent products.

These and other aspects can be realized by the present invention, which is directed to a process for cleaning sludge from crude oil storage tanks, comprising providing a stream of crude oil including a high solvent power (HSP) crude oil, wherein the HSP crude oil has a solubility blending number (SBN) greater than 100, and processing the stream through a storage tank for storing crude oil to dissolve asphaltene-rich sludge in the storage tank. Preferably, providing the stream occurs on a scheduled basis, such as at least annually.

Processing the stream can also include adding the stream to a blend of two or more incompatible crude oils present in the storage tank that has precipitated asphaltenes to correct the blend.

Prior to processing the HSP stream through the tank, the process can comprise contacting the sludge with a hot oil solvent to dissolve oil-soluble organic components of the sludge in the oil solvent, and removing the oil solvent with the dissolved oil-soluble organic components from the tank. Then, the HSP stream is processed through the tank with agitation of the sludge remaining in the tank, and the HSP oil is removed along with dissolved asphaltenes, waxes and suspended inorganic solids from the tank. Water or water-based solvent can be added to the tank to dissolve inorganics in the sludge and then removed with the dissolved inorganics.

The invention additionally relates to a process for maintaining a crude oil storage tank in a refining facility, comprising adding crude oil including a high solvent power (HSP) crude oil, wherein the HSP crude oil has a solubility blending number (SBN) greater than 100, to a crude oil storage tank to dissolve asphaltene-rich sludge in the storage tank, using the HSP crude oil from the tank in a refining process, and repeating the step of adding the HSP crude oil on a scheduled basis to maintain reduced sludge level in the storage tank.

The invention is also directed to a refinery system comprising crude oil storage tanks, and a crude oil processing assembly, including heat exchange equipment for processing the crude oil. A transport system, such as a pipeline assembly, connects the crude oil storage tanks with the crude oil processing assembly so that crude oil is supplied from the storage tanks to the processing assembly. At least one of the crude oil storage tanks includes a tank designated for storing high solvent power (HSP) crude oil that has solubility blending number (SBN) of at least 100.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is a graph illustrating test results showing reduced fouling by practicing the process in accordance with this invention;

FIG. 2 is a graph illustrating test results showing reduced fouling with several different blends used in the process in accordance with this invention;

FIG. 3 is a graph illustrating test results from an on-line cleaning simulation;

FIG. 4 is a profilimetry analysis of a whole crude oil fouling run;

FIG. 5 is a profilimetry analysis of a blended crude oil cleaning run; and

FIG. 6 is a profilimetry analysis of another blended crude oil cleaning run.

In the drawings, like reference numerals indicate corresponding parts in the different figures.

### DETAILED DESCRIPTION OF PREFERRED EMBODIMENTS

This invention is directed to different aspects of addressing sludge build up in crude oil storage equipment in refineries and petrochemical plants. In a preferred use, the processes are applied to crude oil storage tanks, but may also be used in storage containers for other high gravity petroleum products. For ease of reference, the petroleum products are referred to herein as crude oil, which will be understood to include similar products that experience sludge build up. Of course, it is possible to apply the invention to other processing facilities and heat exchangers, particularly those that are susceptible to build up and also to fouling in a similar manner as experienced during refining processes and are inconvenient to take off line for repair and cleaning.

It has been found that selected crude oils have a higher solvent power for asphaltenes and that streams of these selected crude oils may be used to remove the precipitated asphaltenes from heat exchanger surfaces before solid, adherent coke deposits can be formed. These crude oils are referred to as high solvent power (HSP) crude oils. HSP crude oils are defined as those with solubility blending numbers (SBN) greater than 100 (SBN>100).

For example, in a prior invention, heat exchangers are cleaned by the use of high solvent power (HSP) oil that is admitted to the exchanger and allowed to soak the surfaces for a sufficient period of time to dissolve the asphaltenes. After the period of time, the oil is removed with the dissolved asphaltenes and any loosened deposits, recovered and processed in the refinery by conventional refining operations, e.g., by sending to the coker. This is disclosed in related application U.S. Ser. No. 11/391,258 entitled On-Line Heat Exchanger Cleaning Method, which was filed Mar. 29, 2006, and is now pending. The contents of this related application are incorporated herein by reference.

As discussed above, storage tanks for crude oils tend to experience sludge build up due to precipitation of asphaltenes. This invention approaches the problem of sludge build up through solvent removal using HSP crude oils. These inventors propose using HSP crude oils as a preventive measure to reduce formation and build up of asphaltene-rich sludges in crude oil storage tanks and to prevent fouling of the pre-heat train of refinery processing equipment with an HSP stream.

According to this invention, HSP crude oils are processed through storage tanks to re-dissolve asphaltenes that may have precipitated from solution and formed a build up of asphaltene-rich tank sludges. Such processing dissolves the asphaltene-rich sludge and does not require further handling of the sludge other than standard processing of the crude oil. A blend of oils including an HSP crude oil component will also be effective provided that the SBN level of the blended oil with the HSP component is at least 100. Using this approach, HSP crude oils can also be used to correct poor crude oil blends present in a storage tank that would otherwise result in asphaltene precipitation. Adding a stream of an HSP crude oil or blend to a tank with an incompatible blend will dissolve precipitating asphaltenes and work on the existing sludge level.

Increasing the frequency of tank cleaning with an HSP crude oil will optimize tank sludge level management. Using an HSP crude oil or HSP blend frequently and on a scheduled basis will prevent the build up of sludges and reduce costly cleaning efforts needed when tanks are overloaded. Annual, or more preferably semi-annual, cleaning procedures using HSP crude oils will keep tank sludges from building up to costly levels and minimize the impact on storage capabilities. This differs from current practices in which sludge is addressed when the levels become problematic.

Tank cleaning with an HSP crude oil can also be combined with a selective solvent extraction (SSE) process. This process is described in U.S. Patent Application Publication No. 2006/0042661 published Mar. 2, 2006, which is incorporated herein by reference. The cleaning process involves emptying the tank of the previous liquid hydrocarbon contents, i.e., the product ordinarily stored in the tank, which leaves the semi-solid sludge in the tank. A hot hydrocarbon solvent is introduced into the tank to sufficiently cover the mixers and/or float the roof. The petroleum based solvent acts on the organic portion of the solid sludge material.

Most of the solid hydrocarbons will dissolve more quickly and fully with the use of mixing and heat, which improves the degree and rate of dissolution. If heat is not applied, longer mixing times or repeat solvent applications can be utilized. Following agitation, the hydrocarbon solvent and dissolved materials are pumped from the tank and recovered through conventional refinery processing. The mixture is processed through a refinery process that typically handles solids, such as cat cracking or coking.

Water or water-based solvents are then introduced into the tank to dissolve the inorganic salts, such as chlorides, carbonates, oxides, etc., known to exist in these sludges. The water or water-based solvents and dissolved inorganics are pumped from the tank and processed via the conventional refinery water treating facilities. Employing this process on a scheduled basis, such as annually or semi-annually, can keep the tanks virtually free of sludge, which will improve related refinery operations.

With this invention, tank sludge removal in accordance with the above process can be optimized by using a hydrocarbon solvent product in the form of a fluid catalytic cracking slurry oil, such as cat slurry, clarified slurry oil (CSO), or a heavy aromatic fuel oil (HAFO), for example. This solvent is used in a second phase of the hydrocarbon solvent step with a final slurry back into the catalytic cracking oil product. The use of the product removes the sludge and does not adversely impact the product quality.

According to this process, the first phase of the hydrocarbon solvent step is similar to that above with the liquid hydrocarbon content emptied from the tank, and the hot hydrocarbon solvent introduced into the tank to sufficiently cover the mixers and/or float the roof. No mixing is used in this first phase to avoid stirring-up the inorganic solids in the sludge. The solvent and dissolved sludge components are then pumped back to another crude tank and processed normally through refinery equipment with little impact on operations. In the process disclosed above, the mixture included solids that require processing by cat cracking or coking, for example. In this case, solids are not present so there is no need to schedule the solvent-sludge processing operation, no need to store the mixture waiting for treatment, and little impact on capacity or increased fouling potential.

A second phase is added to the solvent step including introducing more hydrocarbon solvent and agitating the mixture. The remainder of the hydrocarbon solvent along with the dissolved asphaltenes and waxes and the suspended inorganic solids are pumped from the tank and recovered through conventional refinery processing. This second phase uses a different solvent, which is an HSP solvent material that inherently contains inorganic solids. As noted above, this solvent product is a fluid catalytic cracking slurry oil, such as cat slurry, CSO, and HAFO. As this type of solvent inherently contains inorganic solids, the inorganic solids that are stirred into the mixture through agitation do not adversely impact the mixture, which can then be returned to the product system with no special processing.

The water or water-based solvent step is then accomplished. Mixing and heating are not required, but can improve the degree and rate of dissolution. The water or water-based solvents and dissolved inorganics are pumped from the tank and processed via the conventional refinery water treating facilities.

As evident from the processes described above, use of HSP crude oil and HSP crude oil blends enhances tank cleaning and management. However, many refineries do not have immediate access to HSP streams and/or crude oils. Inadequate access can limit the ability of a refinery to optimize operations in the various ways described above. In accordance with this invention, a tank is designated as an HSP crude oil storage tank as part of a refinery or petrochemical plant. Such designation will optimize refinery operations such tank heel blending and management by minimizing asphaltene precipitation; crude oil blending by improving blends to prevent crude pre-heat train exchanger and furnace fouling; storage tank sludge cleaning to remove asphaltenes, waxes and other residues from tanks containing asphalt, cat slurry, and whole crude; debogging of deasphalt units (DAUs); and, on-line and off-line crude pre-heat train heat exchanger cleaning.

The designated HSP storage tank is preferably located where the contents can be easily transported and/or pipelined to the units where the optimization operations can be applied. In one test, a devoted storage tank containing approximately 90% by volume HSP crude oil was charged to a preheat train exchanger as it slowed for downtime so that the unit would soak in a final step prior to a crude unit shutdown at a refinery. The HSP crude tank was also used for the final flush-out of the unit. The preheat train soaked for several days while the furnace was repaired. As a result of using the concentrated HSP crude oil during the soak, the energy efficiency of the preheat train exchangers was improved by ˜15 kbtu/bbl on average. Estimating that if only one-third of this reduction was due to the HSP crude oil wash, savings of ˜$750,000/year at $4.61/MBTU will be realized. In addition to the energy benefits, the crude unit desalter inlet temperature improved to the highest observed level over the previous year. Also, a lower furnace firing intensity was experienced than during the record crude runs earlier in the year. These benefits allowed the unit to process greater amounts of crude and at a greater efficiency. It can be appreciated that a refinery process set up in accordance with these inventions will experience a greater efficiency and cost effectiveness.

To evaluate the relative fouling potentials of crude oils and blends, the commercially available Alcor Hot Liquid Process Simulator (HPLS) is used by these inventors. Alcor runs are carried out by charging the one-liter reservoir with a crude oil or blend, heating the liquid up to 150° C. (302° F.), and pumping it across a vertically positioned, carbon-steel rod with a flow rate of 3.0 mL/minute. The spent oil is collected in the top section of the Alcor reservoir, which is separated from the untreated oil by a sealed piston, thereby allowing for once-through operation. The system is pressurized with nitrogen at 400-500 psig prior to each test run to ensure gases remain dissolved in the oil during the test. The rod is electrically heated to preset temperatures and held constant throughout the run. The rod surface temperature for the tests is 370° C. (698° F.). Thermocouple readings are recorded for the bulk fluid inlet and outlet temperatures and for the surface of the rod. The heated surface thermocouple is positioned inside the rod.

During the fouling tests, asphaltenes deposit on the heated surface and are thermally degraded to coke, which builds up on the surface of the test rod. The coke deposit causes an insulating effect that reduces the efficiency and/or ability of the heated surface to heat the oil passing over it. The resulting reduction in temperature is referred to as the outlet liquid Delta T and is dependent on the type of crude oil/blend, testing conditions and other effects. The test time for these runs is 180 minutes. The test allows 30 minutes of stirring and pre-heat within the reservoir prior to the start of the run. The total fouling, as measured by the total reduction in outlet liquid temperature, is referred to as “Delta T₁₈₀.” It should be noted that the flow regime for the Alcor system is laminar and therefore direct correlation with field experiences is difficult. However, the unit has been proven to be effective in evaluating differences in relative fouling potentials between crude oils and blends.

The Alcor unit standard fouling test parameters are as follows:

| | |
|---|---|
| Flow Rate/Type: | 3.0 mL/minute/once through operation |
| Metallurgy: | Carbon-Steel (1018) heater rods |
| System Pressure: | 400–500 psi |
| Rod Surface Temperature(s): | 370° C. (698° F.) or 400° C. (752° F.) |
| System Temperature Setting | 150° C. (302° F.) |
| (reservoir, pump, lines): | |
| Actual Bulk Fluid Inlet | 105–120° C. (221–248° F.) |
| Temperature: | |

### EXAMPLE 1

An incompatible blend of two crude oils (Blend A) was prepared. The SBN and Iₙ values for Blend A were 30 and 38, respectively. This represents an SBN/Iₙ ratio of 0.81 and is considered to be a “high-fouling” crude oil blend that has precipitated asphaltenes that can deposit onto heated surfaces and thermally degrade to form foulant. Testing of Blend A in the Alcor unit according to the procedure above resulted in a Delta T₁₈₀ of −92° C. In other words, the liquid outlet temperature was reduced by 92° C. as a result of the build up of coke on the rod surface.

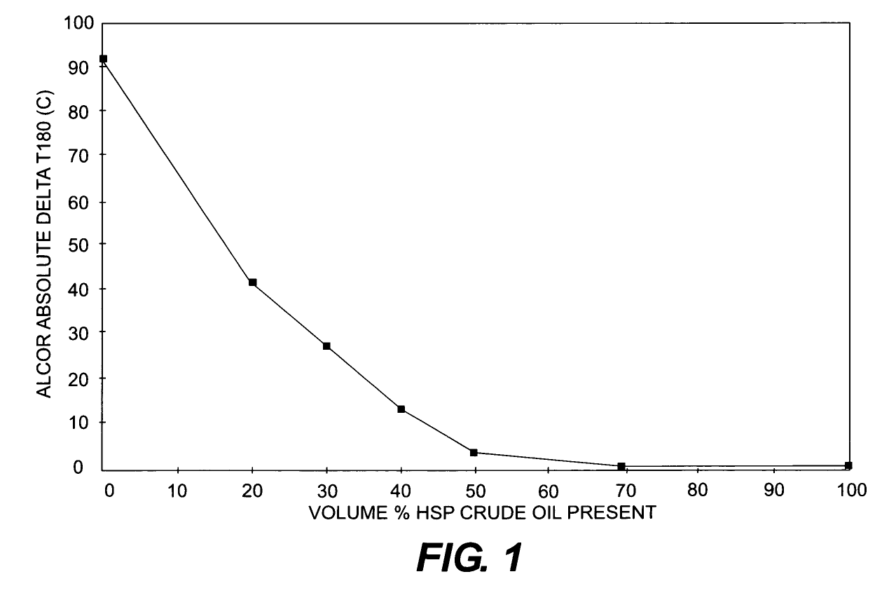

Then, an HSP crude oil with an SBN of 158 was mixed with Blend A in increasing volume proportions. The HSP crude oil had zero Delta T₁₈₀, or is virtually a non-fouling crude oil under Alcor conditions. Each of the Blend A/HSP crude oil blends was tested in the Alcor unit to determine the changes in Delta T₁₈₀. The final Delta T₁₈₀ data from each of the runs are plotted in FIG. 1 as a function of the amount of HSP crude oil added. The plot shows that as the concentration of HSP crude increases, the relative fouling decreases to significantly lower Delta T₁₈₀ values. With greater than 50% by volume HSP present, the fouling potential was reduced to virtually non-fouling levels. These results demonstrate that the addition of HSP crude oil has a significant effect on reducing the fouling potential of asphaltene-containing crude oils and blends.

### EXAMPLE 2

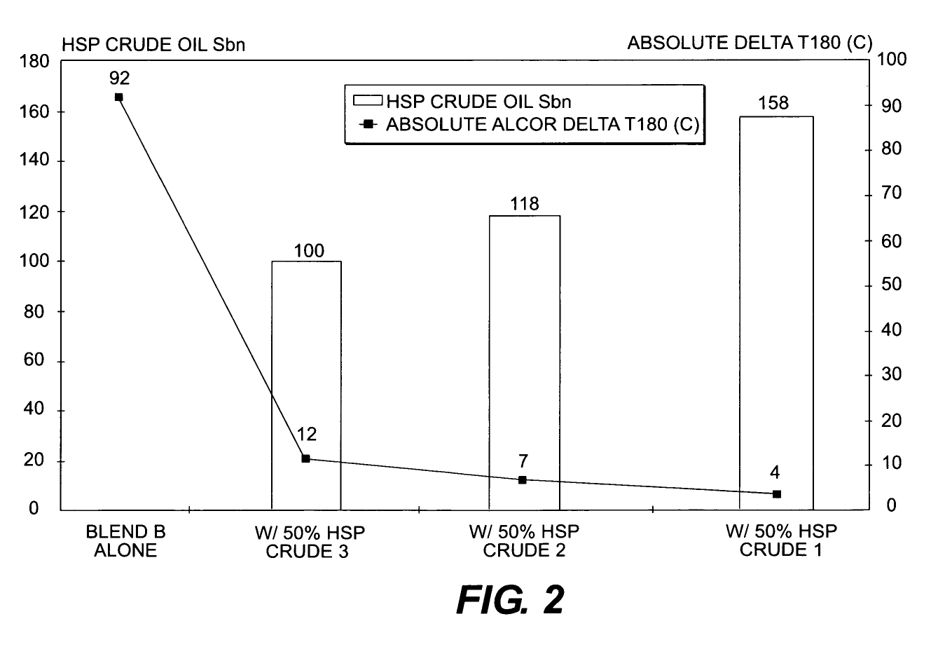

The same high-fouling crude Blend A described in Example 1 was also mixed at 50% by volume with other HSP crude oils with differing SBN levels and tested in the Alcor unit. The results are summarized in FIG. 2. The curve shows the reduction in fouling from the base case as equal volume amounts of increasing SBN crude oils are present. The bars show the actual SBN values for each of the individual HSP crudes used for each test. These results show that the higher SBN HSP streams have a beneficial impact on the relative degree of fouling.

### EXAMPLE 3

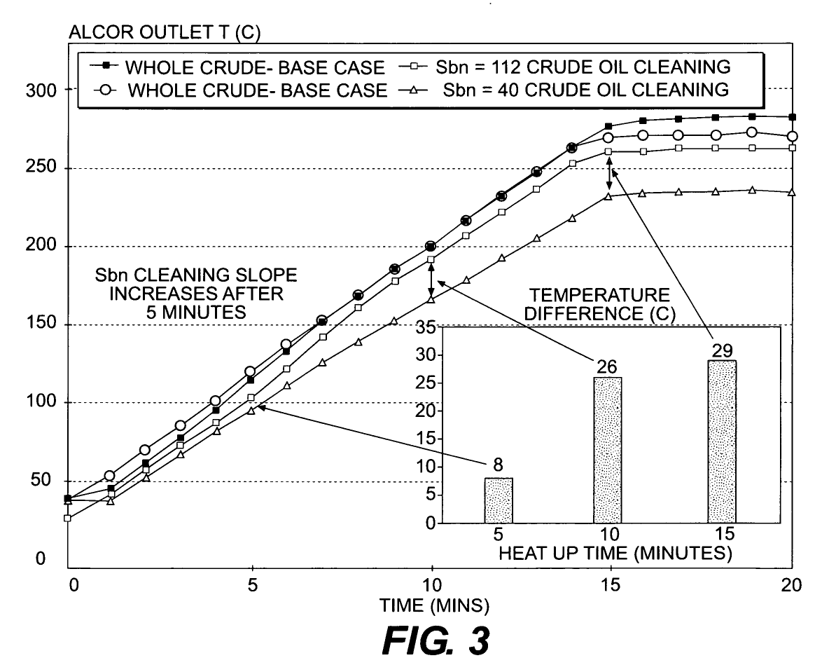

A standard fouling run was made using 370° C. (698° F.) rod surface temperatures to obtain base case data. It required 15 minutes to heat the rod to this temperature. The same fouling run was repeated, and the fouled rod was kept in place for follow-up cleaning testing. First, an HSP whole crude oil with an SBN of 112 was run over the pre-fouled rod. Second, a poor-solvent whole crude oil (SBN=40) was run for comparison. Both of the crude oils are non-fouling crude oils under the conditions used. FIG. 3 shows the results of both test runs. The outlet temperatures obtained as a result of the Alcor rod heating the liquid are plotted. Both base case tests show the crude oil being heated at a linear rate to a maximum of 270-277° C. (518-531° F.). The HSP cleaning test shows that the crude was heated to 261° C. (502° F.), or 97% of the base case 270° C., even though the foulant was initially present on the rod. Such foulants normally insulate the heating effect, thereby reducing the efficiency of the surface to heat the liquid. Examining the data from the HSP cleaning run shows that the slope of the outlet temperature increases significantly after 5 minutes, or after reaching 100° C. This is due to the physical removal of the foulant deposit, thereby exposing more of the rod surface and allowing the heat to transfer to the liquid.

The second cleaning test with the low SBN crude oil shows that the slope did not increase and only a maximum temperature of 232° C. (450° F.) was achieved. This is due to the non-removal of the pre-formed foulant deposit, or the inefficiency of the heat transfer due to the presence of the foulant deposit. The inset bar graph of FIG. 3 shows the difference in outlet temperature between the high and low SBN whole crude oils. After 5 minute, the difference between these is only 8° C., whereas after 10 and 15 minutes of heat up time, the difference in outlet temperature is after 26 and 29° C., respectively. This reflects the difference in the amount of deposit remaining on the heater rods. In this case, the optimum cleaning time or flush time is between about 5 to 20 minutes, preferably between 5 and 15 minutes.

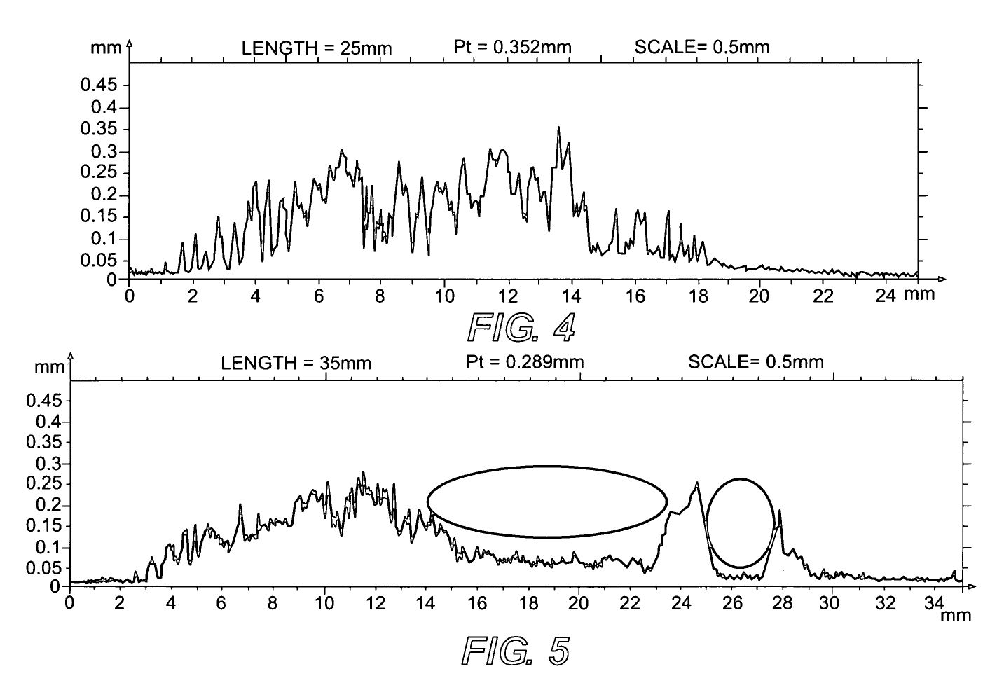

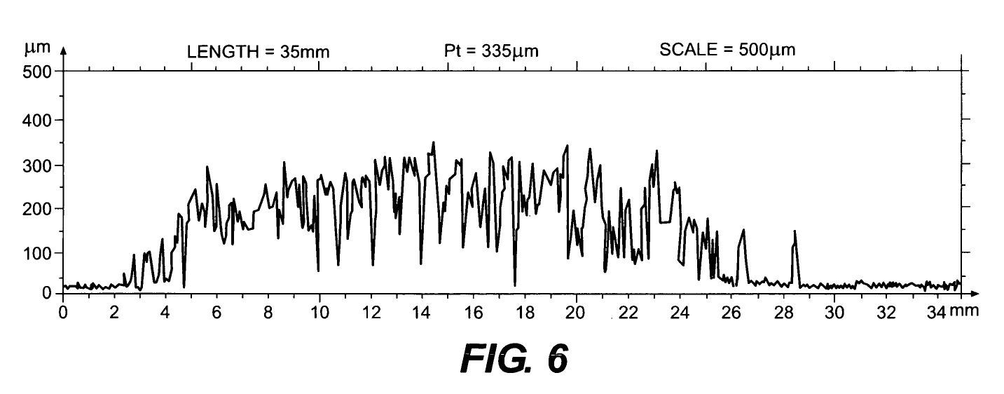

FIGS. 4-6 illustrate additional evidence of selective solvent foulant removal. The results shown in these figures were obtained by testing using profilimetry, which is an analytical technique that allows the examination of the physical shape of the foulant deposit on the rod. FIG. 4 shows the profile for the base case rod after a whole crude oil fouling run. FIG. 5 shows the profile for the base case rod after a high SBN (SBN=112) crude oil cleaning run. The circled portions having a lower profile show the cleaned portions of the Alcor rod deposit. FIG. 6 shows the profile for the base case rod after a low SBN (SBN=40) crude oil cleaning run. FIG. 6 shows that there is no effect compared to the profile shown in FIG. 4. The results confirm those obtained from the Alcor testing that only the HSP whole crude oil was capable of removing the foulant deposit and improving the heat transfer efficiency of the system.

Thus, these inventors have shown that HSP crude oil has the ability to dissolve asphaltene precipitates and provide an effective method for cleaning tanks and managing sludge levels in storage containers. Feeding streams of HSP oils through tanks can clear out sludge, correct incompatible blends in tank heels, maintain low or minimal sludge levels when used in a regular basis, and optimize other cleaning procedures. Providing access to HSP oils in refinery systems can maximize use of these beneficial oils and increase efficiency in refining systems. It can be appreciated that significant labor, time savings, and reduced cost will be realized.

It will be recognized by those of ordinary skill in the art that the invention can be applied to any storage facility for use with petroleum products.

Various modifications can be made in the invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

What is claimed is:

1. A process for cleaning sludge from crude oil storage tanks, comprising:
providing a stream of crude oil including a high solvent power (HSP) crude oil, wherein the HSP crude oil has a solubility blending number (SBN) greater than 100; and
processing the stream through a storage tank for storing crude oil to dissolve asphaltene-rich sludge in the storage tank.

2. The process of claim 1, wherein processing the stream includes adding the stream to a blend of two or more incompatible crude oils present in the storage tank that has precipitated asphaltenes.

3. The process of claim 1, wherein providing the stream occurs on a scheduled basis.

4. The process of claim 3, wherein the scheduled basis is at least annually.

5. The process of claim 3, wherein the scheduled basis is at least semi-annually.

6. The process of claim 1, wherein prior to processing the HSP stream through the tank, the process further comprises:
contacting the sludge with a hot oil solvent to dissolve oil-soluble organic components of the sludge in the oil solvent; and
removing the oil solvent with the dissolved oil-soluble organic components from the tank,
wherein processing the HSP stream through the tank includes agitating the sludge remaining in the tank and then removing the HSP oil along with dissolved asphaltenes, waxes and suspended inorganic solids from the tank.

7. The process of claim 6, wherein the HSP stream includes a fluid catalytic cracking slurry oil having inorganic solids therein.

8. The process of claim 6, further comprising:
adding a water or water-based solvent to the tank to dissolve inorganics in the sludge; and,
removing the water or water-based solvent and dissolved inorganics from the tank for processing.

9. The process of claim 1, wherein the HSP crude oil is a blend with at least 50% HSP by volume.

10. The process of claim 1, wherein the HSP crude oil has an SBN greater than 110.

11. The process of claim 1, wherein the HSP crude oil has an SBN greater than 150.

12. The process of claim 1, wherein the stream of crude oil is an unprocessed crude oil or a processed oil derived from petroleum.

13. The process of claim 1, wherein the HSP oil is provided from a designated storage container.

14. A process for maintaining a crude oil storage tank in a refining facility, comprising:
adding crude oil including a high solvent power (HSP) crude oil, wherein the HSP crude oil has a solubility blending number (SBN) greater than 100, to a crude oil storage tank to dissolve asphaltene-rich sludge in the storage tank;
using the HSP crude oil from the storage tank in a refining process; and,
repeating the step of adding the HSP crude oil on a scheduled basis to maintain reduced sludge level in the storage tank.

15. The process of claim 14, wherein the HSP crude oil is added to a tank heel that includes a blend of two or more incompatible crude oils.

16. The process of claim 14, wherein the scheduled basis is at least annually.

17. The process of claim 14, wherein the HSP crude oil is added from a designated storage tank that forms part of the refining facility.

18. A refinery system, comprising:
crude oil storage tanks;
a crude oil processing assembly, including heat exchange equipment for processing the crude oil; and
a transport system connecting the crude oil storage tanks with the crude oil processing assembly so that crude oil is supplied from the storage tanks to the processing assembly,
wherein at least one of the crude oil storage tanks includes a tank designated for storing high solvent power (HSP) crude oil that has solubility blending number (SBN) of at least 100.

19. The refinery system of claim 18, wherein the transport system selectively connects the tank designated for storing HSP crude oil to other crude oil storage tanks and selectively connects the tank designated for storing HSP crude oil to the crude oil processing assembly.

20. The refinery system of claim 18, wherein the transport system connects the tank designated for storing HSP crude oil based on a predetermined schedule.

21. The refinery system of claim 18, wherein the transport system is a pipeline.

22. A process for cleaning sludge from crude oil storage tanks, comprising:
contacting the sludge with a hot oil solvent to dissolve oil-soluble organic components of the sludge in the oil solvent without mixing or agitation;
removing the oil solvent with the dissolved oil-soluble organic components from the tank for processing;
introducing additional hydrocarbon solvent that is an HSP solvent material to contact the sludge and agitating the mixture;
removing the HSP solvent material for processing;
adding a water or water-based solvent to the tank to dissolve inorganics in the sludge; and,
removing the water or water-based solvent and dissolved inorganics from the tank for processing.

23. The process of claim 22, wherein removing the HSP solvent material includes removing dissolved asphaltenes, waxes and suspended inorganic solids from the tank.

24. The process of claim 22, wherein the HSP solvent material includes a fluid catalytic cracking slurry oil having inorganic solids therein.

25. The process of claim 22, further comprising the step of emptying the tank of liquid hydrocarbon contents to leave sludge in the tank for treatment prior to the step of contacting the sludge with the hot oil solvent.

26. The process of claim 22, wherein the process is practiced on a periodic predetermined schedule.

27. The process of claim 22, wherein the HSP solvent material is provided as a stream directly from a designated HSP crude oil storage container.
